(19) United States
(12) Patent Application Publication
(10) Pub. No.: US 2024/0400223 A1
(43) Pub. Date: Dec. 5, 2024

(54) METHOD FOR ASSISTING THE LANDING OF AN AIRCRAFT AND SYSTEM CONFIGURED FOR EXECUTING SAME

(71) Applicant: Airbus Operations (S.A.S.), Toulouse (FR)

(72) Inventor: Juan RIVERO SESMA, Toulouse (FR)

(21) Appl. No.: 18/673,398

(22) Filed: May 24, 2024

(30) Foreign Application Priority Data
May 31, 2023 (FR) 2305453

(51) Int. Cl. B64D 45/08

(52) U.S. Cl. CPC B64D 45/08

(57) ABSTRACT

A method for assisting landing of an aircraft on a landing runway of a destination airport facility includes two successive determinations of the position of the aircraft with respect to the landing runway and based on a photographic image taken from the aircraft, respectively according to two different algorithms for determining the position of the aircraft, together with the supply of at least one piece of information representative of a difference between the two determined positions. It is thus possible to verify whether the destination landing runway observed from the photographic image taken from the aircraft is indeed the target destination runway on which a landing of the aircraft is planned, or whether there exists an error in positioning of the aircraft with respect to the destination landing runway.

### TECHNICAL FIELD

The disclosure herein relates to a method for assisting the landing of an aircraft on a runway of an airport. The disclosure herein relates more particularly to a method for determining the position of the aircraft with respect to one or more runways of an airport facility, using a photographic image taken from the aircraft, then for verifying the coherence of the position determined. The disclosure herein furthermore relates to a system configured for executing the aforementioned landing assistance method.

### BACKGROUND

Current aircraft comprise numerous flight assistance devices or systems amongst which are for example systems to assist the implementation of an optimized descent towards a destination airport facility or else systems aimed at avoiding any confusion upon arriving at the destination between a destination landing runway and a taxiway parallel to this runway. Furthermore, some airports are not equipped with instrument landing systems (or ILS) allowing an automatic landing of an aircraft.

Many airport facilities comprise several runways, sometimes arranged parallel to one another, and a risk of confusion may occur under conditions of poor visibility, or else in the absence of positioning means available for automatic positioning of an aircraft with respect to a runway. There accordingly exists a need to confirm a correct positioning of an arriving aircraft on final approach towards a destination runway of an airport facility.

The situation can be improved.

### SUMMARY

One subject of the disclosure herein is to provide a method for assisting the landing of an aircraft allowing a correct positioning of the aircraft with respect to a destination landing runway of an airport facility to be confirmed, notably when the latter comprises a plurality of landing runways, together with an automated landing assistance system configured for executing such a method.

For this purpose, a method is provided for assisting the landing of an aircraft on a predefined landing runway of a destination airport facility, the method comprising a determination of a first position of the aircraft with respect to the predefined landing runway, based on a photographic image taken from the aircraft, on coordinates of the landing runway in a database, and on a first algorithm for determining a position of the aircraft with respect to the runway using the photographic image, the method being such that it furthermore comprises:
a determination of a second position of the aircraft with respect to the destination landing runway, based on a photographic image taken from the aircraft, on the coordinates of the destination landing runway in the database, and on a second algorithm for determining a position of the aircraft with respect to the runway using the photographic image, different from the first algorithm for determining a position of the aircraft with respect to the runway using the photographic image, then,
providing information representative of the difference between the first determined position and the second determined position.

It is thus advantageously possible to verify the coherence of the runway observed from the aircraft arriving at the planned destination landing runway such as it appears in a database of the landing runways, and to do this without geolocation systems (such as a GPS system, for example).

According to one embodiment, the airport comprises a plurality of landing runways and the method for assisting the landing of an aircraft is designed and adapted such that it comprises, for each of the landing runways of the destination airport facility, considered successively:
a determination of a first position of the aircraft with respect to the landing runway being considered, based on a photographic image taken from the aircraft, on coordinates of the landing runway from all the runways of the airport in a database, and on the first algorithm for determining a position of the aircraft with respect to the runway using the photographic image,
a determination of a second position of the aircraft with respect to the destination landing runway, based on a photographic image taken from the aircraft, on the coordinates of the destination landing runway in the database, and on the second algorithm for determining a position of the aircraft with respect to the runway using the photographic image, different from the first algorithm for determining a position of the aircraft with respect to the runway using the photographic image, then,
recording information representative of the difference between the first determined position and the second determined position, in association with an identifier of the landing runway being considered, then,

compare the two recorded pieces of information representative of the two smallest differences in position between the first determined position and the second determined position from amongst the list of the recorded information representative of the differences in position between the first position and the second position in association with the landing runways, and, if the difference between the two pieces of information representative of the two smallest differences in position exceeds a predetermined threshold value:

supply information representative of the difference between the first determined position and the second determined position for the runway for which the difference is the smallest from amongst the list of recorded information representative of the differences, in association with an identifier of the runway for which the difference is the smallest,
and otherwise:
supply information representative of the difference between the first determined position and the second determined position for the runway for which the difference is the smallest from amongst the list of recorded information representative of the differences.

According to one embodiment, the method for assisting the landing of an aircraft on a runway of a destination airport facility executes algorithms for determining a position of the aircraft comprising at least:
the first algorithm which is an algorithm of the “Perspective-n-Point” type comprising a method for determining a translation between a landing runway and a current position of the aircraft, together with a method for determining a rotation between the landing runway and the current position of the aircraft, and,
the second algorithm which comprises a method for determining a translation between a landing runway and a current position of the aircraft, together with an acquisition of a position of the aircraft based on information provided by an inertial navigation system of the aircraft.

Another subject of the disclosure herein is a device for assisting the landing of an aircraft on a predefined landing runway of a destination airport facility, the device comprising electronic circuitry configured for carrying out a determination of a first position of the aircraft with respect to the predefined landing runway, based on a photographic image taken from the aircraft, on coordinates of the runway in a database, and on a first algorithm for determining a position of the aircraft with respect to the runway using the photographic image, the assistance device furthermore comprising electronic circuitry configured for carrying out:
a determination of a second position of the aircraft with respect to the landing runway, based on a photographic image taken from the aircraft, on the coordinates of the landing runway in the database, and on a second algorithm for determining a position of the aircraft with respect to the runway using the photographic image, different from the first reprojection algorithm, and for,
supplying information representative of the difference between the first determined position and the second determined position.

According to one embodiment, the landing assistance device of an aircraft comprises electronic circuitry configured for, when the airport facility comprises a plurality of landing runways, performing for each of the landing runways of the destination airport facility, considered successively:
a determination of a first position of the aircraft with respect to the landing runway being considered, based on a photographic image taken from the aircraft, on coordinates of the landing runway in a database, and on the first algorithm for determining a position of the aircraft with respect to the runway using the photographic image,
a determination of a second position of the aircraft with respect to the landing runway, based on a photographic image taken from the aircraft, on the coordinates of the runway in the database, and on the second algorithm for determining a position of the aircraft with respect to the runway using the photographic image, different from the first algorithm for determining a position of the aircraft with respect to the runway using the photographic image, then,
recording information representative of the difference between the first determined position and the second determined position, in association with an identifier of the landing runway being considered, then for

comparing the two recorded pieces of information representative of the two smallest differences in position between the first determined position and the second determined position from amongst the list of recorded information representative of the differences in position between the first determined position and the second determined position, in association with the landing runways, and, if the difference between the two pieces of information representative of the two smallest differences in position exceeds a predetermined threshold value:

supply information representative of the difference between the first determined position and the second determined position for the runway for which the difference is the smallest from amongst the list of recorded information representative of the differences,

and otherwise:

supply information representative of the difference between the first determined position and the second determined position for the runway for which the difference is the smallest from amongst the list of recorded information representative of the differences.

According to one embodiment, the assistance device furthermore comprises electronic circuitry configured for:
executing a first algorithm of the “Perspective-n-Point” type comprising a method for determining a translation between a landing runway and a current position of the aircraft, together with a method for determining a rotation between the landing runway and the current position of the aircraft, and,
executing a second algorithm comprising a method for determining a translation between a landing runway and a current position of the aircraft, together with an acquisition of a position of the aircraft based on information provided by an inertial navigation system of the aircraft.

Another subject of the disclosure herein is an aircraft comprising a landing assistance device such as previously described.

The disclosure herein lastly relates to a computer program product comprising program code instructions for executing the steps of a landing assistance method such as previously described, together with a storage medium comprising a computer program product such as the aforementioned.

### BRIEF DESCRIPTION OF THE DRAWINGS

The aforementioned features of the disclosure herein, together with others, will become more clearly apparent upon reading the following description of one example embodiment, the description being presented in relation to the appended drawings:

FIG. 1 illustrates schematically and symbolically an aircraft comprising a landing assistance system according to one embodiment approaching a destination landing runway;

FIG. 2 illustrates schematically a projection of the destination landing runway already shown in FIG. 1 in an image plane of a frontal camera of an aircraft allowing a position of the aircraft with respect to this runway to be determined;

FIG. 3 illustrates schematically a landing assistance method according to one embodiment;

FIG. 4 illustrates schematically and symbolically an aircraft comprising a landing assistance system according to one embodiment, approaching a destination airport comprising a plurality of landing runways;

FIG. 5 illustrates schematically a landing assistance method according to another embodiment; and,

FIG. 6 illustrates schematically an internal architecture of a landing assistance device according to one embodiment.

### DETAILED DESCRIPTION

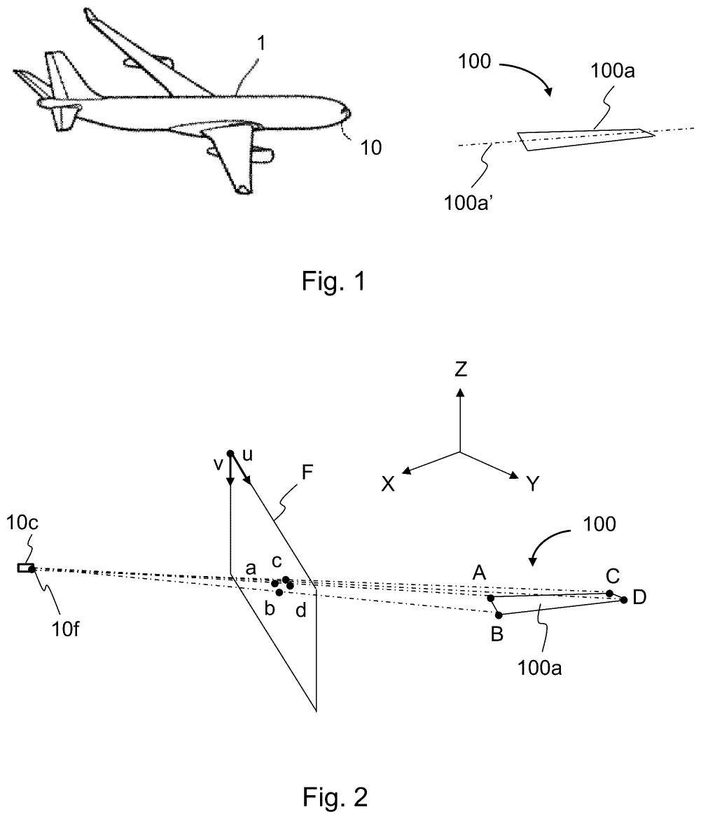

FIG. 1 shows schematically and symbolically an aircraft 1 comprising a landing assistance system 10 configured for executing a landing assistance method according to one embodiment of the disclosure herein. The system 10 is notably configured for determining a position of the aircraft 1 with respect to a destination landing runway 100a on which the aircraft 1 is about to land. The destination landing runway 100a is a runway of an airport 100. The landing runway 100a of the airport 100 is elongated and extends along a central axis 100a′. Advantageously, the destination landing runway 100a is referenced in a database RWYDB directly or indirectly accessible by the landing assistance system 10 of the aircraft 1. According to one embodiment, the database RWYDB is downloaded into the assistance system 10 of the aircraft 1, for example prior to a flight. According to one embodiment, the database RWYDB comprises, for each of the runways of airport facilities which are listed in it, coordinates of characteristic points of the runway (corners and middle of the thresholds of runways, for example) according to a World Geodesic System format WGS84. According to one embodiment, the landing assistance system 10 is configured for communicating with a remote server, for example a database server installed in a ground station which comprises the airport runway database RWYDB. Advantageously, the aircraft 1 is equipped with at least one frontal camera 10c (shown in FIG. 2) which is configured for taking photographic images of a sector called “front sector”, towards which the aircraft is directed when it is in flight. Preferably, the frontal camera 10c is arranged within the radome of the aircraft 1. According to variants, the frontal camera 10c is arranged on any given part of the fuselage of the aircraft as long as its position is compatible with a photographic image of the front sector, which sector is furthermore globally visible from the cockpit of the aircraft 1. The frontal camera 10c works as a conventional image capture device, in other words it is configured for taking successive photographic images and for supplying successive images F each representing a view of the environment in front of the aircraft 1, from the aircraft 1, at the time the image is taken. According to one embodiment, the frontal camera 10c is for example configured for taking 30 images per second and for supplying 30 images F per second to the landing assistance device 10. Advantageously, the camera 10c or else the landing assistance system comprises a module for detecting regions of interest configured for detecting one or more regions of interest appearing in a photographic image, using a corresponding one of the images F. In other words, the module for detecting a region of interest is a module comprising electronic circuitry configured for detecting one or more objects (regions of interest) of a given type in an image F obtained from the frontal camera 10c. According to the example described, the object or objects detected are landing runways. According to one embodiment, the object detection module comprises a software or hardware implementation of a deep artificial neural network or of the DCNN (acronym for “Deep Convolutional Neural Network”) type. Such a DCNN module may be composed of an assembly of many artificial neurons, of the convolutional type or of the perceptron type, organized by interconnected successive layers. Such a DCNN module is conventionally inspired from a simplistic model of the operation of a human brain where numerous biological neurons are interconnected by axons. For example a module referred to as YOLOv4 (acronym for “You Only Look Once version 4”) is a module of the DCNN type which allows a detection of objects to be carried out in images, and which is referred to as “One-Stage”, in other words whose architecture is composed of a single module of combined propositions of rectangles framing objects (“bounding boxes”) and of classes of objects in the image. In addition to the artificial neurons previously described, the module YOLOv4 uses functions known to those skilled in the art such as, for example, ‘batch normalization’, ‘dropblock regularization’, ‘weighted residual connections’ or a ‘non-maximal suppression step’ which eliminates the redundant propositions from detected objects. According to one embodiment, the module for detecting objects has the possibility of predicting a list of objects present in one or more images of one or more video contents supplying, for each object, a rectangle bounding the object in the form of coordinates of points defining the rectangle in the image, the type or class of the object from amongst a predefined list of classes defined during a learning phase, and a detection score representing a degree of confidence in the detection thus carried out. Advantageously, the module for detecting objects working on an image F is configured for extracting coordinates of points characteristic of each of the landing runways detected in an image F, with reference to the image plane (or image reference frame) of the image F. For example, the object detection module of the aircraft 1 is capable of supplying coordinates of the four corners of a landing runway detected in an image F, together with two points defining a longitudinal central axis of the runway being considered. The image plane of the frontal camera 10c is defined here as a plane perpendicular to the optical axis of the frontal camera 10c and an image supplied by the camera 10c therefore comprises a projection of all the elements seen by the camera in this reference image plane.

Ingeniously and advantageously, it is then possible, for any landing runway whose characteristic points are referenced in a geolocation database of landing runways, to use the coordinates present in the database or else coordinates of points determined using coordinates present in the database, together with the coordinates of the same points of the runway such as detected in an image F obtained from the frontal camera taking a photograph in order to supply this image F, for defining a position POS1 of the aircraft at the time the photograph from which the image F comes is taken, by virtue of the use of an algorithm for determining a position of the “Perspective-n-Point” type commonly referred to as “PnP algorithm”. This is an algorithm aimed at determining the relative position according to six degrees of freedom of a camera (or more precisely of its optical centre), positioned on its optical viewing axis, with respect to an object being considered in space, and vice-versa, based on a set of correspondences of the points Mi referenced in a spatial reference frame X, Y, Z and their respective projections mi in an image plane obtained from the camera. Thus, for example an algorithm for determining a position of an aircraft with respect to an object in space such as a landing runway can determine a position of the camera 10c based on the geodetic coordinates of the corners A, B, C, D of the runway 100a and on the coordinates in the image F (and hence in the graphical reference frame of the image F) of the points a, b, c, d which are the representation of the points A, B, C and D in the image F supplied by the frontal camera 10c.

FIG. 2 illustrates a relative position of the aircraft 1 in flight approaching the destination landing runway 100a whose four corners are identified and referenced A, B, C, D. FIG. 2 furthermore illustrates an image F such as supplied by the frontal camera 10c of the aircraft 1 and in which a representation of the runway 100a can be seen, detected by the object detection module of the aircraft 1 configured for detecting one or more landing runways in the image F supplied by the frontal camera 10c. The image F comprises a representation a, b, c, d, in the reference frame u, v of coordinates of the points of the image F, of the characteristic points A, B, C and D that are the corners of the landing runway 100a in the real world. According to one embodiment, geodetic coordinates xA, yA, zA; xB, yB, zB; xC, yC, zC and xD, yD, zD respectively associated with the points A, B, C, D are known and recorded in the database RWYDB of the landing runways with reference to a spatial reference frame X, Y, Z.

According to one embodiment, the landing assistance system 10 of the aircraft 1 is configured for determining and determines, for at least one image F, a first position POS1 of the optical centre 10f of the camera 10c, and hence, as a consequence, of the aircraft 1 with respect to the landing runway 100a by virtue of a first algorithm, of the PnP algorithm type. The PnP algorithm executed according to the disclosure herein, also referred to as algorithm for determining a relative position between two objects, and which notably works here by generating a projection or “reprojection” of a destination runway (here the landing runway 100a) in an image plane of the frontal camera 10c (here, for example, the image plane of the image F), is not further detailed in the present description since the many calculation operations performed according to such an algorithm are known and its detailed description is not useful for the understanding of the disclosure herein.

Furthermore, the landing assistance system 10 of the aircraft 1 is configured for determining and determines, for at least the image F, a second position POS2 of the optical centre 10f of the camera 10c, and hence, as a consequence, of the aircraft 1 with respect to the landing runway 100a by virtue of a second algorithm, different from the first algorithm and which also carries out a determination of a position of the aircraft 1 with respect to the destination runway (here again, the landing runway 100a), for example by taking into account the attitude of the aircraft 1 at the time of the determination of this second position POS2. The attitude of the aircraft 1 here denotes the position of the axes of the aircraft 1 with reference to roll, yaw and pitch axes, such as, by way of example, the reference frame X, Y, Z shown in FIG. 2. Advantageously and ingeniously, the landing assistance system 10 of the aircraft 1 is configured for calculating a difference in position Δ_{POS1, POS2} between the two determined positions POS1 and POS2, then for supplying information representative of this difference in position Δ_{POS1, POS2}. For example, if the difference in position Δ_{POS1, POS2} is less than a predetermined threshold S1, this means that the two positions POS1 and POS2 are coherent with respect to one another and that the position of the aircraft 1 is correct with respect to the destination landing runway 100a on which it is about to land. In this case, the landing assistance system supplies information G according to which the position of the aircraft is satisfactory with a view to landing on the destination runway 100a. In the opposite case, in other words if the difference Δ_{POS1, POS2} between the two determined positions POS1 and POS2 exceeds the threshold S1, this means that there exists an incoherence between the positions POS1 and POS2 and the landing assistance system supplies information B according to which an incoherence exists and must be taken into account for the following operations with a view to landing.

The two pieces of information G and B may take various forms, for example a term displayed on a control screen, a pictogram, an audio or haptic signal. It goes without saying that the information G and B encompass forms that are sufficiently different so as to be easily differentiated. According to one example embodiment, the information G is a green indicator lamp activated with reference to a runway identifier on an approach chart and the information B is a flashing red indicator lamp accompanied by an audible warning signal, additionally with a haptic signal.

According to one embodiment, each of the pieces of information G and B may initiate subsequent processing operations, such as for example a flight assistance process in final approach towards the destination runway 100a as far as the information G is concerned, or a process of interruption of the of landing procedure (go-around with engine throttle) as far as the information B is concerned.

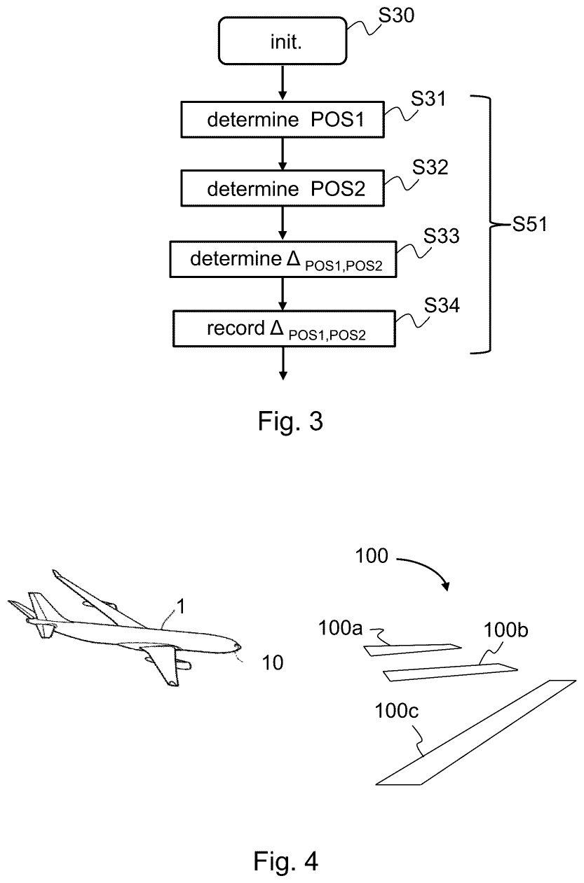

FIG. 3 is a flow diagram illustrating steps of a method for assisting the landing of the aircraft 1 executed by the landing assistance system 10.

A step S30 is an initial step following which the assistance system is normally operational, the frontal camera 10c takes successive photographic images and the object detection module of the aircraft 1 identifies at least one representation of a landing runway in an image F supplied by the frontal camera 10c. In particular, following the step S0, the landing assistance system 10 disposes of representations of characteristic points in the image F of characteristic points of the destination runway 100a such as referenced in the database RWYDB of landing runways for aircraft.

A first position POS1 of the aircraft 1 with respect to the destination landing runway 100a is subsequently determined at the step S31, via the execution of the first algorithm for determining a position of the aircraft 1, of the PnP type, then a second position POS2 of the aircraft 1 with respect to the destination landing runway 100a is subsequently determined at the step S32, via the execution of the second algorithm for determining a position of the aircraft 1, different from the first algorithm for determining a position of the aircraft 1.

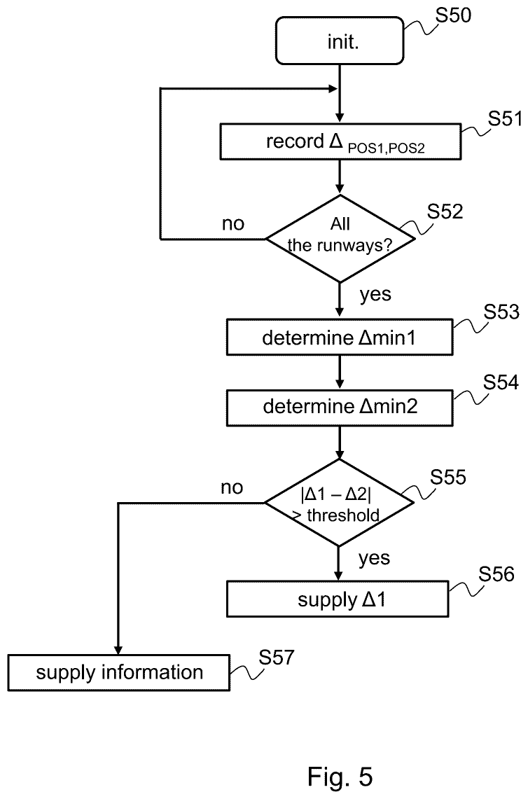

According to one embodiment, the first algorithm, of the PnP type, comprises a method for determining a translation T between a destination landing runway and a current position of the aircraft 1, together with method for determining a rotation R between the destination landing runway and the current position of the aircraft 1, and the second algorithm comprises a method for determining a translation T between a landing runway and a current position of the aircraft 1, together with an acquisition of a more precise position of the aircraft 1 based on information supplied by an inertial navigation system of the aircraft (successive information on movements of the aircraft along a roll axis, a pitch axis and a yaw axis, together with the accelerations relating to them). Such an inertial navigation system (or INS) is an instrument used in navigation, configured for measuring the movements of the aircraft and in particular determining (or estimating) values of acceleration and of velocity, for the purpose of successively estimating its orientation in space (roll, pitch and heading angles with respect to a spatial reference frame, also referred to as “attitude of the aircraft”), together with its linear speed and its position. The estimation of position is relative to the point of departure of the aircraft or to an intermediate reset point. Such an inertial navigation system INS has the capacity to provide flight navigation data such as the heading, the route, the drift, the speed, and the position. Ingeniously, the second algorithm for determining a position of the aircraft 1 with respect to the destination landing runway of the aircraft 1 is therefore sufficiently different from the first algorithm for determining a position of the aircraft with respect to the destination landing runway of the aircraft 1 so as to detect an incoherence in determined position of the aircraft 1, for example, in the case of confusion linked to a degradation of the conditions for taking a photographic image from the camera 10c (depending on the weather conditions, for example), or if a runway close to the destination runway is detected but that the aircraft is not correctly positioned in front of the destination runway on which it is about to land. A difference in position Δ_{POS1, POS2}=|POS1−POS2| is subsequently determined by the landing assistance system 10 at the step S33, then is recorded in a memory of the aircraft 1 during a step S34. Information representative of the difference in position Δ_{POS1, POS2}=|POS1−POS2| is then supplied with a view to subsequent processing. It should be noted that the steps S31, S32, S33 and S35 constitute a sequence or step S51 such as described later in the description in relation to FIG. 5, in one example embodiment adapted to the case where the destination airport comprises a plurality of landing runways amongst which is the destination landing runway.

FIG. 4 illustrates schematically the existence of a plurality of landing runways 100a, 100b and 100c of the airport facility 100 which comprises the destination landing runway 100a towards which the aircraft 1 is flying and on which the aircraft 1 intends to land.

FIG. 5 is a flow diagram illustrating a landing assistance method according to one advantageous embodiment when the destination airport 100 comprises a plurality of landing runways such as, for example, the runways 100a, 100b and 100c already described in relation to FIG. 4. According to one embodiment, the landing assistance method described here carries out the method previously described in FIG. 3 for each of the landing runways 100a, 100b and 100c existing at the airport and detected by the frontal camera 10c of the aircraft 1, then subsequently considers the two landing runways for which the difference in position determined with respect to this runway is the smallest and subsequently performs a filtering aimed at eliminating an error of the “false positive” type prior to supplying the final information.

For this purpose, an initialization step S50 constitutes an initial step following which the assistance system 10 is normally operational, the frontal camera 10c takes successive photographic images and the object detection module of the aircraft 1 identifies a plurality of representations of landing runways in an image F supplied by the frontal camera 10c. In particular, following the step S50, the landing assistance system 10 disposes of representations of characteristic points in the image F of characteristic points of the destination runways 100a, 100b and 100c such as referenced in the database RWYDB of landing runways for aircraft.

A step S51 is subsequently carried out as many times as there are landing runways detected in the image F supplied by the frontal camera 10c. The step S51 aims to record information representative of a difference in position with respect to the landing runway being considered (from amongst the runways 100a, 100b and 100c detected in the image F) obtained by comparing two positions of the aircraft 1 by the use of two algorithms for determining a position of an aircraft with respect to a given landing runway and using an image supplied by the frontal camera 10c. The step S51 is a sequence composed of the steps S31, S32, S33 and S34 previously described in relation to FIG. 3. After each iteration of the step 51, it is verified, during a step S52, whether all the landing runways detected in the image F have been processed by the step S51. If this is the case, the method continues in sequence to a step S53, and otherwise, the method loops back to the step S51 for processing one of the landing runways detected not yet processed by the step S51. Thus, if n landing runways are detected in the image F, or more exactly three representations of landing runways are detected in the image F, the method iteratively executes three times the step S51 and it is possible to write that n=3 is the number of landing runways to be processed, and the step S51 is carried out iteratively with a repetition index i going from 1 to n, so as to define, for each of the landing runways detected, a first determined position POS1i using a first algorithm for determining a position of an aircraft, such as “A2”, and a second determined position POS2i using a second algorithm for determining a position of an aircraft, such as “A2” (Attitude), different from the first algorithm for determining a position of an aircraft. According to the example described, when the three landing runways detected in the image F have been processed, the landing assistance system 10 therefore disposes of six determined positions, with two positions determined for each of the three landing runways detected in the image F:

| | POSITION | POSITION |
|---|---|---|
| RUNWAY | according to “PnP” | according to “A2” |
| RUNWAY 100a | POS11(x11, y11, z11) | POS21 (x21, y21, z21) |
| RUNWAY 100b | POS12(x12, y12, z12) | POS22 (x22, y22, z22) |
| RUNWAY 100c | POS13(x13, y13, z13) | POS23 (x23, y23, z23) |

The differences in positions successively determined during the iterations of the step S51 are:

| Rank i | RUNWAY | DIFFERENCE \|POS1 − POS2\| |
|---|---|---|
| 1 | RUNWAY 100a | Δ1_{POS11, POS21} |
| 2 | RUNWAY 100b | Δ2_{POS12, POS22} |
| 3 | RUNWAY 100c | Δ3_{POS13, POS23} |

It is subsequently determined, at a step S53, which is the runway for which the difference in determined position is the smallest (the least) between the positions POS1i and POS2i. Then, it is determined, at a step S54, which is the runway for which the difference in determined position is the second smallest between the positions POS1i and POS2i.

The runway for which the difference in position |POS1i-POS2i| is the smallest is here denoted Δmin1_{Pos1i, POS2i},

and the runway for which the difference in position |POS1i-POS2i| is the second smallest is denoted Δmin2_{POS1i, POS2i}.

According to one example embodiment, the smallest difference is:

Δmin1_{POS1i, POS2i}=Δ2_{POS12, POS22},

and the second smallest difference from amongst Δ1_{POS11, POS21}, Δ2_{POS12, POS22} and Δ3_{POS13, POS23} is:

Δmin2_{POS1i, POS2i}=Δ1_{POS11, POS21}.

A filtering is subsequently carried out during a step S55 aimed at detecting whether the differences Δmin1_{POS1i, POS2i}=Δ2_{POS12, POS22} and Δmin2_{POS1i, POS2i}=Δ1_{POS11, POS21} are numerically far enough from one another to avoid any risk of confusion between the two runways for which the level of coherence of the determined position of the aircraft 1 is the highest. In other words, it is defined here whether it is possible to discriminate, without risk of error, between the runway for which the difference between the positions POS1 and POS2 is the least and the other runways detected and considered successively at the step S51.

In the case where the difference between Δmin1P_{OS1i, POS2i} and Δmin2_{POS1i, POS2i} is greater than a predetermined threshold value S2, there is a good discrimination and the landing assistance system 10 supplies the flying crew of the aircraft 1 and/or a system of the aircraft 1 with information representative of this difference in association with an identifier of the runway being considered, aiming at indicating that there exists a good correlation (or coherence) between the position of the aircraft 1 and the runway being considered, which amounts to saying that the runway being considered is that situated in front of the aircraft 1. Thus, if this is the destination runway, the provision of the information representative of Δmin1_{POS1i, POS2i} in association with an identifier of the runway confirms a correct positioning of the aircraft 1 flying towards this destination runway. According to one embodiment, the information representative of the difference Δmin1_{POS1i, POS2i} is the difference Δmin1_{POS1i, POS2i} itself. In the case where the difference between Δmin1_{POS1i, POS2i} and Δmin2_{POS1i, POS2i} is not greater than the predetermined threshold value S2, the landing assistance system 10 provides the crew piloting the aircraft 1 and/or a system of the aircraft 1, during a step S57, with information according to which it is not possible to discriminate between the two landing runways for which the determined respective differences in position of the aircraft 1 with respect to the runway being considered are the smallest from amongst all those determined for the runways detected. According to one embodiment, when it is not possible to discriminate between the two landing runways for which the determined respective differences in position of the aircraft 1 with respect to the runway being considered are the smallest, the landing assistance system 10 does not supply any information, which then amounts to considering that the system is not capable of confirming a correct positioning of the aircraft 1 with respect to the intended destination runway.

According to one variant embodiment, information representative of the difference in position between the positions POS1i and POS2i is supplied by the landing assistance system for each of the landing runways detected in the image F obtained from the frontal camera 10c. For example, an indicator associated with an identifier of each of the runways detected illustrates a level of difference between the positions respectively determined via the two algorithms for runway reprojection in the image plane of the image F. The indicator may be a displayed level, a bar graph, a colour of an indicator light, by way of examples.

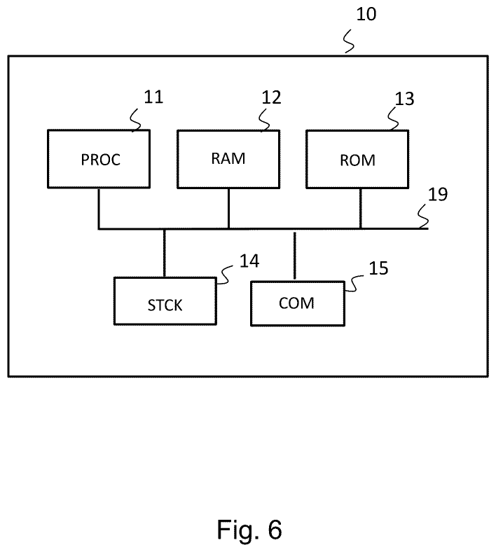

FIG. 6 is a schematic representation of one example of internal architecture of the landing assistance system 10, also here referred to as landing assistance device 10. It is considered by way of illustration that FIG. 6 illustrates an internal arrangement of the landing assistance system 10 such as that on board the aircraft 1. It is noted that FIG. 6 could also illustrate schematically one example hardware architecture of the landing assistance system 10 according to a configuration where the landing assistance system 10 is external to the aircraft 1 and communicates with the latter via one or more wireless communication links.

According to the example of hardware architecture shown in FIG. 6, the landing assistance system 10 thus comprises, connected via a communication bus 19: a processor or CPU (for Central Processing Unit) 11; a volatile memory RAM (for Random Access Memory) 12; a non-volatile memory ROM (for Read Only Memory) 13; a storage unit such as a hard disk (or a storage medium reader such as an SD (for Secure Digital) card reader) 14; a communications interface module 15 allowing the landing assistance system 10 to communicate with remote devices, such as other onboard systems in the aircraft 1, amongst which is the frontal camera 10c, a database server, or else such as the aircraft 1 itself.

The processor 11 of the landing assistance system 10 is capable of executing instructions loaded into the RAM 12 from the ROM 13, from an external memory (not shown), from a storage medium (such as an SD card), or from a communications network. When the landing assistance system 10 is powered up, the processor 11 is able to read instructions from the RAM 12 and to execute them. These instructions form a computer program causing the implementation, by the processor 11, of all or part of a landing assistance method described in relation to FIG. 3 or of all or part of a landing assistance method described in relation to FIG. or of variants described of these methods.

All or part of the methods described in relation to FIG. 3 and FIG. 5, or their variants described, may be implemented in a software form by execution of a set of instructions by a programmable machine, for example a DSP (for Digital Signal Processor) or a microcontroller, or be implemented in a hardware form by a machine or a dedicated component, for example an FPGA (for Field-Programmable Gate Array) or an ASIC (for Application-Specific Integrated Circuit). In general, the landing assistance system 10 comprises electronic circuitry configured for implementing the methods described in relation to itself. It goes without saying that the landing assistance system 10 furthermore comprises all the usual elements present in a system comprising a control unit and its peripherals, such as a power supply circuit, a power supply management circuit, one or more clock circuits, a reset circuit, input-output ports, interrupt inputs, bus drivers, this list being non-exhaustive.

The disclosure herein is not limited to those examples and embodiments described hereinabove but relates more widely to any landing assistance method and any system executing this method carrying out a comparison of two positions of the aircraft determined with respect to a predefined destination runway, based on a photographic image taken from a frontal camera of the aircraft, on information extracted from a shared database of characteristic features of landing runways and on at least two different algorithms for reprojection of a destination runway in an image plane of the frontal camera.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for assisting landing of an aircraft on a predefined landing runway of a destination airport facility, the method comprising a determination of a first position of the aircraft with respect to the predefined landing runway, based on a photographic image taken from the aircraft, on coordinates of the runway in a database, and on a first algorithm for determining a position of the aircraft with respect to the runway using the photographic image, the method comprising:
a determination of a second position of the aircraft with respect to the landing runway, based on the photographic image taken from the aircraft, on the coordinates of the runway in the database, and on a second algorithm for determining a position of the aircraft with respect to the runway using the photographic image, different from the first algorithm; then,
supplying information representative of a difference between the first determined position and the second determined position.

2. The method for assisting landing of an aircraft according to claim 1, wherein the airport comprises a plurality of landing runways, the method comprising, for each of the landing runways of the destination airport, considered successively:
a determination of a first position of the aircraft with respect to an i^{th} landing runway being considered, based on a photographic image taken from the aircraft, on coordinates of the i^{th} runway in a database, and on the first algorithm,
a determination of a second position of the aircraft with respect to the i^{th} landing runway, based on a photographic image taken from the aircraft, on the coordinates of the i^{th} runway in the database, and on the second algorithm, different from the first algorithm; then,
recording information representative of the difference between the first determined position and the second determined position, in association with an identifier of the i^{th} runway being considered; then,
comparing the recorded information representative of two smallest differences in position between the first position and the second position from amongst a list of recorded information representative of the differences in position between the first position and the second position in association with the landing runways, and, if the difference between the two pieces of information representative of the two smallest differences in position exceeds a predetermined threshold value:
supplying information representative of the difference between the first determined position and the second determined position for the runway for which the difference is the smallest from amongst the list of recorded information representative of the differences in position;
and otherwise:
supplying information according to which it is not possible to discriminate between the two landing runways associated with the two pieces of information representative of the two smallest differences in position.

3. The method for assisting landing of an aircraft on a runway of a destination airport according to claim 1, wherein:
the first algorithm is an algorithm of a “Perspective-n-Point” type comprising a method for determining a translation between a landing runway and a current position of the aircraft, together with a method for determining a rotation between the landing runway and the current position of the aircraft; and,
the second algorithm comprises a method for determining a translation between a landing runway and a current position of the aircraft, together with an acquisition of the position of the aircraft using information supplied by an inertial navigation system of the aircraft.

4. A device for assisting landing of an aircraft on a predefined landing runway of a destination airport facility, the device comprising electronic circuitry configured for carrying out a determination of a first position of the aircraft with respect to the predefined landing runway, based on a photographic image taken from the aircraft, on coordinates of the runway in a database, and on a first algorithm for determining a position of the aircraft with respect to the runway using the photographic image, the device comprising electronic circuitry configured for carrying out:
a determination of a second position of the aircraft with respect to the landing runway, based on a photographic image taken from the aircraft, on the coordinates of the runway in the database, and on a second algorithm for determining a position of the aircraft with respect to the runway using the photographic image, different from the first reprojection algorithm; and for,
supplying information representative of a difference between the first determined position and the second determined position.

5. The device for assisting landing of an aircraft according to claim 4, comprising electronic circuitry configured for, when the airport comprises a plurality of landing runways, performing for each of the landing runways of the destination airport, considered successively:
a determination of a first position of the aircraft with respect to the landing runway being considered, based on a photographic image taken from the aircraft, on coordinates of the runway in a database, and on the first algorithm;
a determination of a second position of the aircraft with respect to the landing runway, based on a photographic image taken from the aircraft, on the coordinates of the runway in the database, and on the second algorithm, different from the first algorithm; then,
recording information representative of a difference between the first determined position and second determined position, in association with an identifier of the runway being considered; then for
comparing the recorded information representative of two smallest differences in position between the first position and the second position from amongst a list of recorded information representative of the differences in position between the first position and the second position, in association with the landing runways, and, if the difference between the two pieces of information representative of the two smallest differences in position exceeds a predetermined threshold value:
supplying information representative of the difference between the first determined position and the second determined position for the runway for which the difference is the smallest from amongst the list of recorded information representative of the differences, in association with an identifier of the runway for which the difference is the smallest;
and otherwise:
supplying information according to which it is not possible to discriminate between the landing runways associated with the two pieces of information representative of the two smallest differences in position.

6. The device according to claim 4, comprising electronic circuitry configured for:
executing a first algorithm of a “Perspective-n-Point” type comprising a method for determining a translation between a landing runway and a current position of the aircraft, together with a method for determining a rotation between the landing runway and the current position of the aircraft; and,
executing a second algorithm comprising a method for determining a translation between a landing runway and a current position of the aircraft, together with an acquisition of an altitude of the aircraft at the current position of the aircraft using information supplied by an inertial navigation system of the aircraft.

7. An aircraft comprising the device according to claim 4.

8. A computer program product comprising program code instructions for executing the method according to claim 1 when the instructions are executed by a processor of a landing assistance device of an aircraft.

9. A storage medium comprising a computer program product according to claim 8.
